(19) United States
(12) Patent Application Publication
(10) Pub. No.: US 2003/0034377 A1
(43) Pub. Date: Feb. 20, 2003

(54) Combustion tool with coil magazine

(76) Inventors: Chris H. Porth, Gurnee, IL (US); Milovan A. Nikolich, St. Thomas, VI (US)

Correspondence Address: Lisa M. Soltis, Illinois Tool Works Inc., 3600 West Lake Avenue, Glenview, IL, 60025, US

(21) Appl. No.: 09/930,930

(22) Filed: Aug. 16, 2001

(51) Int. Cl. B25C 1/14

(52) U.S. Cl. 227/10

(57) ABSTRACT

A combustion powered fastener driving tool includes a cylinder head and a cylinder defining a combustion chamber, a nosepiece assembly connected to the cylinder and defining a drive track for accommodating a reciprocating driver blade powered by combustion in the combustion chamber, a fastener advancing mechanism associated with the nosepiece assembly for feeding a supply of fasteners to said drive track and a delivery apparatus for providing a supply of gas from the combustion chamber for actuating the fastener advancing mechanism. The fastener advancing mechanism is configured for receiving fasteners from a coil magazine.

### BACKGROUND OF THE INVENTION

The present invention relates generally to tools for driving fasteners, and more particularly to cordless tools suitable for use with magazines configured for dispensing a strip of fasteners arranged in a coil.

It is generally known to supply fasteners, for example trim nails, from a coiled strip of fasteners housed in a magazine of a fastener driving tool, for example a trim nailing tool. The coiled strip of fasteners generally includes a plurality of individual fasteners arranged and held in parallel, spaced relationship by a flexible carrier formable in a coil and disposed in the magazine as is well known in the art.

Typically, such coil-type fastener driving tools have been pneumatically powered, as is disclosed in U.S. Pat. Nos. 6,152,346; 5,772,098 and 6,170,730, which are incorporated by reference. In a tool of this type, a pawl-type feed assembly is used to advance the fasteners from the canister-type magazine to the drive track of the tool. The drive track is where a reciprocating driver blade engages the fastener and drives it into a workpiece. In most driver blade engages the fastener and drives it into a workpiece. In most embodiments, the drive track is associated with a tool guide body which defines a passage for fasteners from the magazine to the drive track. A pawl is provided in the guide body and is shiftable toward and away from the drive track by a pneumatically operated cylinder, to which the pawl is pivotally attached. In many common mechanisms of this type, the cylinder operates against a biasing force provided by a spring.

Once a first fastener is loaded into the drive track and is driven, the pawl pivots out of the way of the second fastener, grabs the third fastener in the coil and pulls it toward the drive track, simultaneously pushing the second fastener into the now empty drive track. This retraction and advancement of the pawl takes place at the end of each tool cycle so that a fastener is located in the drive track and the tool is ready for the initiation of the next tool cycle.

A drawback of conventional coil fastener driving tools of this type is that they are pneumatically driven, and as such need to be connected to a source of compressed air, typically by a hose. The pull of the hose adds a weight to the tool during operation, and the operator must constantly work around the presence of the hose during fastening. Thus, the presence of the hose is a nuisance to the operator.

Portable combustion powered tools for use in driving fasteners into workpieces are described in commonly assigned patents to Nikolich, U.S. Pat. Nos. Re. 32,452; 4,403,722; 4,483,473; 4,483,474; 4,552,162; 5,197,646 and 5,263,439, all of which are incorporated herein by reference. Similar combustion powered nail and staple driving tools are available from ITW-Paslode under the IMPULSE® brand. Such tools incorporate a generally pistol-shaped tool housing enclosing a small internal combustion engine. The engine is powered by a canister of pressurized fuel gas also called a fuel cell. A battery-powered electronic power distribution unit or electronic sending unit produces the spark for ignition, and a fan located in the combustion chamber provides for both an efficient combustion within the chamber, and facilitates scavenging, including the exhaust of combustion by-products. The engine includes a reciprocating piston having an elongate, rigid driver blade disposed within a piston chamber of a cylinder body.

Upon the pulling of a trigger, which causes the ignition of the gas in the combustion chamber, the piston and the driver blade are shot downward to impact a positioned fastener and drive it into the workpiece. As the piston is driven downward, a displacement volume enclosed in the piston chamber below the piston is forced to exit through one or more exit ports provided at a lower end of the cylinder. After impact, the piston then returns to its original or “ready” position through differential gas pressures within the cylinder. Fasteners are fed into the nosepiece from a supply assembly, such as a magazine, where they are held in a properly positioned orientation for receiving the impact of the driver blade.

A drawback of conventional portable combustion powered tools of this type is that the typically spring-fed fastener magazines only hold about 50-60 fasteners. Also, such tools have been unable to accommodate the coil-type magazines described above, which typically hold about 200-275 fasteners, due to the lack of a satisfactory power source for advancing the fasteners from the coil magazine to the driver track.

Thus, a first object of the present invention is to provide an improved portable combustion powered fastener tool which has a fastener advancing mechanism suitable for use with coil magazines.

Another object of the present invention is to provide an improved portable combustion powered fastener tool with a fastener advancing mechanism driven by the combustion system.

Still another object of the present invention is to provide an improved portable combustion powered, fastener tool configured for using combustion-generated gas for driving a pneumatically-operated fastener advancing mechanism of the type, suitable for use with coil magazines.

### BRIEF SUMMARY OF THE INVENTION

The above-identified objects are met or exceeded by the present combustion tool suitable for use with a coil magazine, wherein the combustion apparatus provides gas for actuating a pneumatically-operated fastener advancing mechanism. A passageway provides a path for pressurized gas to move from the combustion chamber to overcome a normally biased indexing piston for advancing a fastener toward the driver track for driving into a workpiece by a reciprocating driver blade.

More specifically, a combustion powered fastener driving tool includes a cylinder head and a cylinder defining a combustion chamber, a nosepiece assembly connected to the cylinder and defining a drive track for accommodating a reciprocating driver blade powered by combustion in the combustion chamber, a fastener advancing mechanism associated with the nosepiece assembly for feeding a supply of fasteners to said drive track and a delivery apparatus for providing a supply of gas from the combustion chamber for actuating the fastener advancing mechanism. The fastener advancing mechanism is configured for receiving fasteners from a coil magazine.

### BRIEF DESCRIPTION OF THE SEVERAL VIEWS OF THE DRAWINGS

FIG. 1 is a side elevational view of the present tool; and

FIG. 2 is a vertical section of an opposite side of the tool shown in FIG. 1;

FIG. 3 is a fragmentary elevational view of the tool shown in FIG. 2;

FIG. 4 is a plan view taken along the line 4-4 of FIG. 2 and in the direction indicated generally; and

FIG. 5 is a perspective view taken along the line 5-5 of FIG. 2 and in the direction indicated generally.

### DETAILED DESCRIPTION OF THE INVENTION

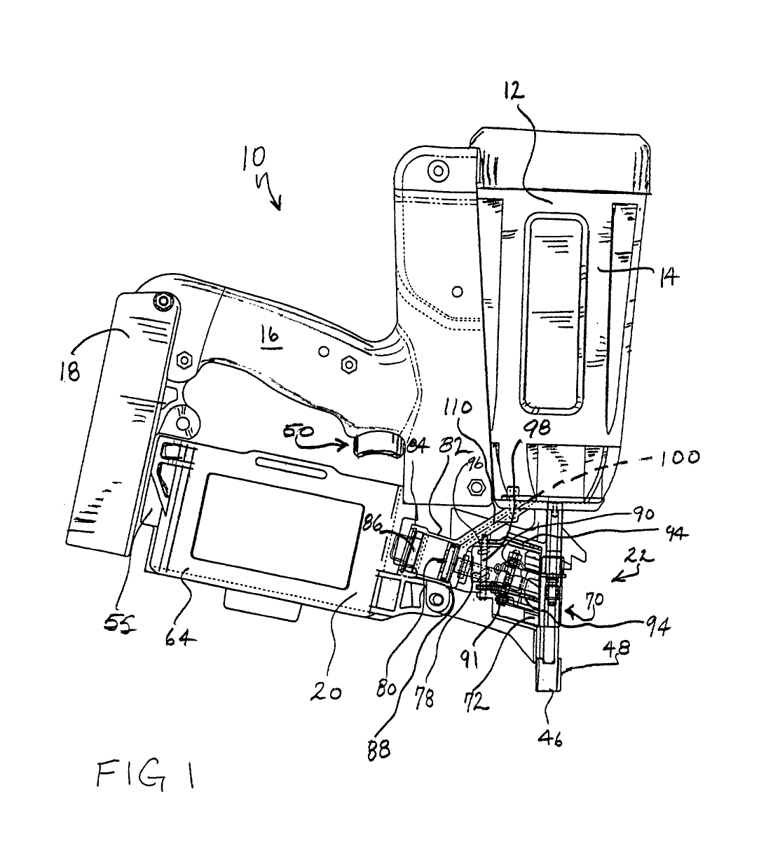

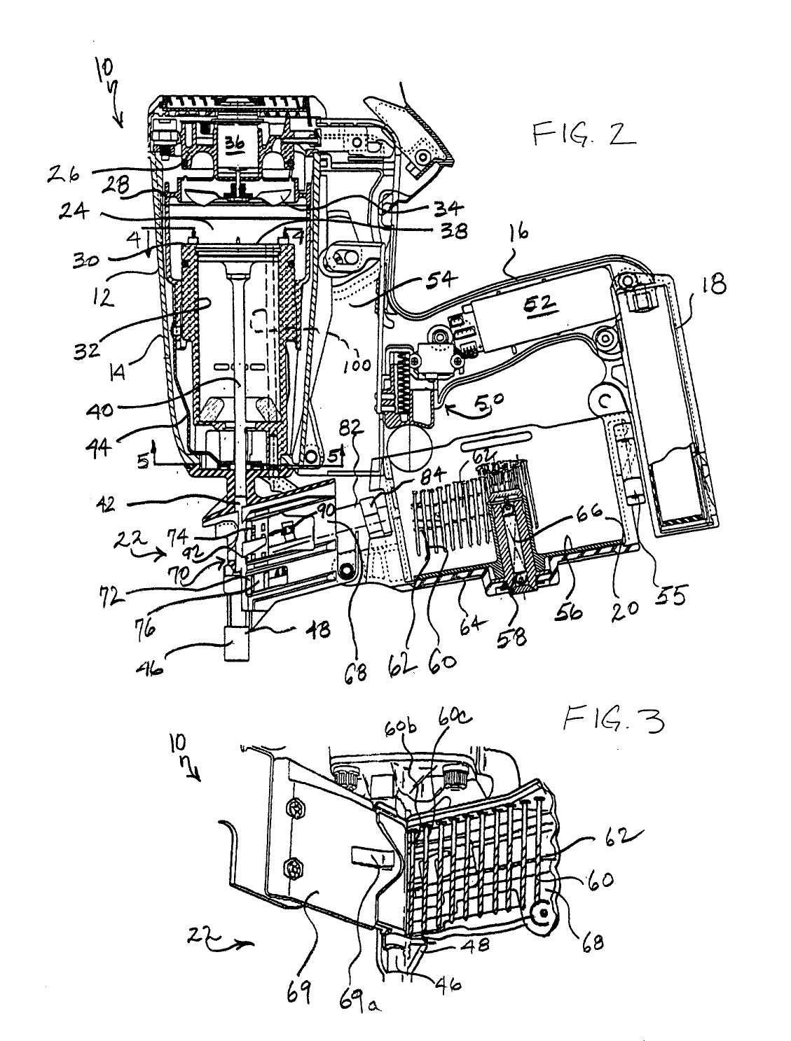

Referring now to FIGS. 1 and 2, a combustion powered fastener driving tool of the type suitable for incorporating the present invention is generally designated 10. The details and operation of the tool 10 are described in the patents which have been incorporated by reference, specifically U.S. Pat. Nos. Re. 32,452; 4,403,722; 4,483,473; 4,483,474; 4,552,162; 5,197,646 and 5,263,439.

The tool 10 includes a housing 12 with a combustion portion 14, a handle portion 16, a battery compartment 18, a magazine 20 and a nosepiece assembly 22. In the combustion portion 14, a combustion chamber 24 is defined by a cylinder head 26, a valve member 28 and an upper portion 30 of a cylinder or sleeve 32. As is well known in such tools bearing the IMPULSE® mark, a fan 34 powered by a motor 36 is preferably disposed within the combustion chamber 24 to facilitate proper mixing of fuel gases, and exhausting spent combustion products.

A piston 38 is located within the cylinder 32 for reciprocal movement and is provided with a depending driver blade 40 which reciprocates within a drive track 42 defined by the nosepiece assembly 22. The valve member 28 is connected by a linkage 44 to a workpiece contact element 46 at a lower end 48 of the nosepiece assembly 22. Pressing the tool down upon a workpiece into which a fastener is to be driven will cause the workpiece contact element 46 to retract relative to the nosepiece assembly 22, moving the valve member 28 closer to the cylinder head 26 to fully close the combustion chamber 24.

A trigger assembly is generally designated 50 and is located in the handle portion 16, as is an electronic control unit 52 (ECU). As is known in the art, upon actuation of the trigger assembly 50, the ECU provides for the generation of a spark in the combustion chamber 24 to ignite collected fuel for causing the driving movement of the piston 38 and the driver blade 40. A supply of pressurized fuel (not shown) is located in a fuel compartment 54 located within the housing and adjacent the combustion portion 14. The type of fuel, and the manner in which it is metered and delivered to the combustion chamber is described in further detail in the patents incorporated by reference herein. At least one battery (not shown) is disposed in the battery compartment 18 for powering the ECU.

The magazine 20 is preferably hinged to the housing 12, and in the depicted embodiment the hinge point is located adjacent the battery compartment 18. In the magazine, a generally circular fastener plate or platen 56 indexes upon a central post 58 and supports a plurality of fasteners 60 held together in generally parallel, spaced relationship to each other by a strip 62. As is typical in such tools, the strip 62 of fasteners is wound around the post 58. The post 58 is attached to a magazine housing 64, and the plate 56 is attached to the post with a spring 66. Additional structural details of the magazine 20 are described in U.S. Pat. No. 6,152,346, which is incorporated by reference.

Referring now to FIGS. 1-3, the type of fastener 60 can vary to suit the application, but is some type of nail or equivalent fastener which can be driven by the driver blade 40 using a forceful impact blow. It is contemplated that any form of the strip 62 is acceptable which retains the fasteners in the desired orientation. Such strips 62 are well known in the art. A free end of the strip 62 of the fasteners 60 is accommodated within the nosepiece assembly 22 in a fastener channel 68. It will be appreciated that the nosepiece assembly 22 also includes a pivoting latchable door 69 which encloses the fastener channel 68 and also provides at least one additional pawl 69a to retain the strip 62 of fasteners 60 in position. Such doors 69 are well known in the art associated with nosepiece assemblies for pneumatic-powered fastener tools.

A fastener advancing mechanism, generally designated 70, is associated with the nosepiece assembly for feeding a supply of fasteners to the drive track 42. Included in the mechanism 70 is a feed claw 72 which is an elongate member having a plurality of teeth 74 in a pair of spaced, parallel rows which define a fastener retention groove 76. The feed claw 72 is oriented to be generally parallel to the longitudinal axis of the driver blade 40. Further, the feed claw 72 is reciprocally movable toward and away from the drive track 42 through a connection to a rod 78 of a piston 80 located within an indexing cylinder 82, also part of the nosepiece assembly 22. At a blind end 84 of the indexing cylinder 82 is a spring 86 which normally exerts a biasing force on the piston 80 toward a rod end 88. This biasing force urges the feed claw 72 close to the drive track 42.

Another feature of the feed claw 72 is that it is pivotable about its longitudinal axis relative to the piston rod 78. A claw spring 90 mounted on an axis pin 91 transverse to the piston rod 78 urges the feed claw 72 towards, rather than away from, the fastener channel 68 so that the teeth 74 project into the channel to engage fasteners 60 on the strip 62. However, the claw spring 90 is flexible enough to allow the feed claw 72 to pivot away from the fastener channel 68 as the feed claw is drawn away from the drive track 42 and encounters the next-to-be-driven fastener 60b on the strip 62 (assuming the first fastener in the strip 62 is located in the drive track 42 for driving by the driver blade 40). As is known in the art, the feed claw 72 must pivot around the second fastener 60b as it is retracted away from the drive track 42 by the action of the piston 80 toward the blind end 84, so that, once the second fastener is bypassed, the third fastener 60c can be engaged and indexed forward, or toward the drive track 42.

The claw teeth 74 on the feed claw 72 engage the third fastener 60c in the fastener retention groove 76 and, once engaged, move it toward the drive track 42 under the power of the spring 86. This action moves the entire strip 62 forward in the fastener channel 68, or toward the drive track 42. As the feed claw 72 is moved back toward the drive track 42, a front edge 92 of the feed claw engages the second fastener and pushes it into the drive track 42. At this point, the driver blade 40 has been retracted from driving the first fastener and the drive track 42 is clear. The fastener 60b is retained in the drive track 42 by at least one and preferably two holding pawls 94 (best seen in FIG. 1) which are biased toward the fastener channel 68 by a pawl spring 96 which is wound around a pawl spring pin 98.

In the “rest” position, with the first fastener 60 in the drive track 42 and the driver blade 40 retracted and waiting combustion, the feed claw 72 is urged toward the drive track by the spring 86 acting on the piston 80. In this scenario, once the trigger assembly 50 initiates combustion, there is no way to overcome the biasing force of the spring 86 to cause the advancement of the strip 62 by the fastener advancing mechanism 72 so that a subsequent fastener can be urged into the drive track 42.

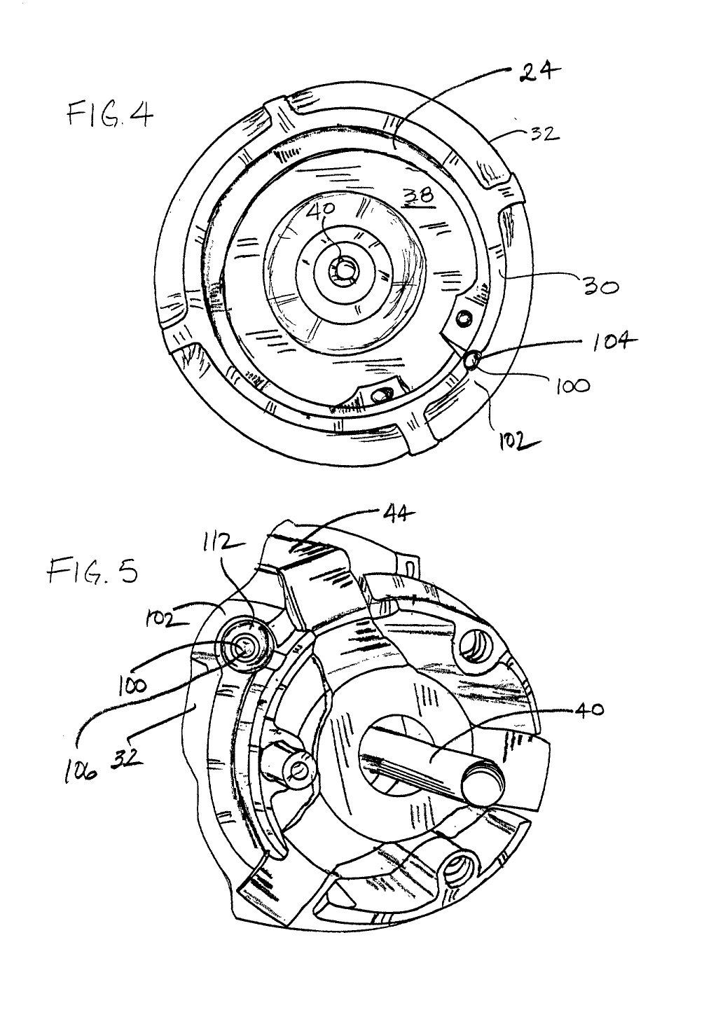

Referring now to FIGS. 2, 4 and 5, an important feature of the present invention is the provision of a source of air pressure to actuate the fastener advancing mechanism 72. More specifically, the present tool 10 incorporates a delivery device for providing a supply of gas from the combustion chamber 24 for actuating the fastener advancing mechanism 72. In the preferred embodiment the delivery device includes a passageway 100 which is in fluid communication with the combustion chamber 24 and the fastener advancing mechanism 72, specifically the indexing cylinder 82.

Preferably formed in part in a wall 102 of the main cylinder 32, the passageway 100 has a first end 104 in communication with the combustion chamber 24 by terminating at the upper portion 30. Opposite the first end 104 is a second end 106 which is in communication with the indexing cylinder 82. In addition to the first part of the passageway 100 located in the cylinder wall 102, a second part 110 of the passageway 100 is preferably part of the nosepiece assembly 22. An airtight junction is provided by placing a resilient gasket or O-ring 112 (FIG. 5) at the intersection of the second part 110 and the cylinder 32. Thus, upon assembly, the passageway extends from the combustion chamber 24 to the indexing cylinder 82.

In the preferred embodiment, the diameter of the passageway 100 and the diameter of the indexing cylinder 82 are dimensioned to obtain a sufficient volume of pressurized gas from the combustion chamber 24 to overcome the biasing force of the spring 86 sufficiently to allow the indexing of a single fastener, or the cycling of the feed claw 72 to obtain a third fastener and urge a second fastener into the drive track 42. In other words, a sufficient amount of combustion gas is delivered to the indexing cylinder 82 from a single combustion to power or actuate the fastener advancing mechanism 70 to advance a single fastener 60. The diameter of the passageway 100 and the volume of the indexing cylinder 82 may vary to suit the application, including the displacement of the combustion chamber 24, the size of the fasteners to be driven, the force of the spring 86, all of which are variables known to the practitioner of ordinary skill in the art.

Upon combustion, which drives the first fastener 60 located in the drive track 42, a sufficient quantity of pressurized combustion gas is drawn down the passageway 100 to retract the piston 80 against the force of the spring 86, thus pulling the feed claw 72 away from the drive track 42 and around the second fastener 60b. The process of forcing the piston 80 toward the blind end 84 increases the volume and accordingly decreases the pressure of the delivered combustion gas. Once the force of the gas in the indexing cylinder 82 has dissipated, and the indexing action accomplished, the force of the spring 86 overcomes the remaining gas, forces the piston 80 back to the start position and forces the remaining gas back up the passageway 100 and into the combustion chamber 24.

Once in the combustion chamber 24, the gas is exhausted with the other combustion gas as the combustion chamber cyclically opens in the normal mode of operation of the tool 10. As soon as the tool 10 is ready for another combustion, the passageway 100 will be able to deliver another portion of pressurized gas for actuating the fastener advancing mechanism 70. Simultaneously, the action of the fastener advancement mechanism has placed the second fastener 60b into the drive track 42 to be ready for being driven into a workpiece.

Thus, it will be appreciated that the present tool provides a delivery device for delivering a sufficient amount of combustion gas from the combustion chamber to power a fastener advancing mechanism. As a result, a coil magazine can be used with a portable combustion powered fastener driving tool. Users of such high capacity magazines, for example in the siding installation business, will now be able to work without the hindrance of pneumatic supply hoses.

While specific embodiments of the combustion tool with coil magazine of the present invention have been shown and described, it will be appreciated by those skilled in the art that changes and modifications may be made thereto without departing from the invention in its broader aspects and as set forth in the following claims.

What is claimed is:

1. A combustion powered fastener driving tool, comprising:
a cylinder head and a cylinder defining a combustion chamber;
a nosepiece assembly connected to said cylinder and defining a drive track for accommodating a reciprocating driver blade powered by combustion in said combustion chamber;
a fastener advancing mechanism associated with said nosepiece assembly for feeding a supply of fasteners to said drive track; and
delivery means for providing a supply of gas from said combustion chamber for actuating said fastener advancing mechanism.

2. The tool of claim 1 wherein said delivery means includes a passageway in fluid communication with said combustion chamber and said fastener advancing mechanism.

3. The tool of claim 2 further including an indexing cylinder associated with said fastener advancing mechanism, and said passageway is in fluid communication with said cylinder.

4. The tool of claim 2 wherein at least a portion of said passageway is incorporated into a wall of said cylinder.

5. The tool of claim 1 wherein said delivery means is configured to obtain a sufficient amount of combustion gas from a single combustion to power said fastener advancing mechanism to advance a single fastener.

6. The tool of claim 5 wherein said fastener advancing mechanism includes an indexing cylinder having a spring-biased piston, and said delivery means is configured to direct the amount of combustion gas into said cylinder to temporarily retract said piston.

7. The tool of claim 1 wherein said fastener advancing mechanism is configured for receiving fasteners from a coil magazine.

8. A combustion powered fastener driving tool, comprising:
a cylinder head and a cylinder defining a combustion chamber;
a nosepiece assembly connected to said cylinder and defining a drive track for accommodating a reciprocating driver blade powered by combustion in said combustion chamber;
a fastener advancing mechanism associated with said nosepiece assembly for feeding a supply of fasteners to said drive track; and
a passageway associated with said cylinder and in communication with said combustion chamber and said fastener advancing mechanism for providing a supply of gas from said combustion chamber for actuating said fastener advancing mechanism.

9. The tool of claim 8 wherein said passageway is configured for providing an amount of gas sufficient to actuate said fastener advancing mechanism to advance a single fastener to said driver track.

10. The tool of claim 8 wherein said fastener advancing mechanism includes an indexing cylinder having a spring-biased piston, and said delivery means is configured to direct the amount of combustion gas into said cylinder to temporarily retract said piston.

11. A combustion powered fastener driving tool for accommodating fasteners contained in a coil magazine, said tool comprising:
a cylinder head and a cylinder defining a combustion chamber;
a nosepiece assembly connected to said cylinder and defining a drive track for accommodating a reciprocating driver blade powered by combustion in said combustion chamber;
a fastener advancing mechanism associated with said nosepiece assembly for feeding a supply of fasteners to said drive track;
a passageway associated with said cylinder and in communication with said combustion chamber and said fastener advancing mechanism for providing a supply of gas from said combustion chamber for actuating said fastener advancing mechanism;
said fastener advancing mechanism includes an indexing cylinder having a spring-biased piston, and said delivery means is configured to direct the amount of combustion gas into said cylinder to temporarily retract said piston.
